(19) United States
(12) Patent Application Publication
(10) Pub. No.: US 2011/0298731 A1
(43) Pub. Date: Dec. 8, 2011

(54) TOUCH DISPLAY DEVICE AND TOUCH DISPLAY SUBSTRATE THEREOF

(76) Inventors: Chien-Hao Fu, Hsin-Chu (TW); Ming-Chin Lee, Hsin-Chu (TW)

(21) Appl. No.: 12/948,769

(22) Filed: Nov. 18, 2010

(30) Foreign Application Priority Data
Jun. 3, 2010 (TW) 099117946

(51) Int. Cl. G06F 3/041

(52) U.S. Cl. 345/173

(57) ABSTRACT

A touch display substrate of a touch display device includes a pixel array, a peripheral region, at least a driving chip, a plurality of data lines, and a plurality of touch sensing read-out lines disposed in the peripheral region. Each of the touch sensing read-out lines includes a first section and a second section. The first section is electrically connected to the corresponding driving chip and the second section is electrically connected to the pixel array. The second section of at least one of the touch sensing read-out lines includes an initial point and a winding portion. The winding portion is disposed on at least one side of a vertical extending line of the initial point, the winding portion winds to and fro along a horizontal direction and along a vertical direction, and the winding portion is asymmetrical with respect to the vertical extending line of the initial point.

### BACKGROUND OF THE INVENTION

1. Field of the Invention

The present invention relates to a touch display device and a touch display substrate thereof, and more particularly, to a touch display device having uni-resistance data lines and touch signal read-out lines and a touch display substrate thereof.

2. Description of the Prior Art

In all kinds of the consumer electronic products nowadays, the mobile electronic products, such as tablet computer, personal digital assistant (PDA), mobile phone and global positioning system (GPS), have been adopting touch panel widely as human machine interface to reduce the volume of the electronic products. The touch function of the touch panel is mainly performed by a touch sensor array which has a plurality of sensor pads arranged in the horizontal direction and the vertical direction. When users implement input on the surface of the touch panel by fingers or other input devices, capacitance change will occur on the position of the corresponding sensor pads such that the horizontal or the vertical coordinates of the input position can be obtained.

According to the difference in the integration of the touch panel and the display panel, the touch display panels can be classified into on-cell touch display panels and in-cell touch display panels. In the structure of the on-cell touch display panel, the touch panel and the display panel are produced independently, and the touch panel is attached to the surface of the display panel. On the other hand, in the structure of the in-cell touch display panel, the touch panel is produced integrally with the display panel. For example, the touch sensor array and the touch signal read-out lines are formed inside the display panel. The in-cell touch display panel, due to its advantages of slim size and high transmittance, has gradually become the mainstream product of the touch display panel.

However, the touch signal read-out lines which are for communicating touch input signals must be disposed jointly with the conductive lines of the display panel, such as the data lines. Thus, when the resistances between the touch signal readout lines and the data lines do not match, the touch signal read-out lines and the neighbor data lines will interact, causing negative influences on the display quality of the display panel.

### SUMMARY OF THE INVENTION

It is therefore one of the objectives of the present invention to provide a resistance matching touch display panel and a touch display substrate thereof.

In accordance with an embodiment of the present invention, a touch display panel comprises a pixel array, a peripheral region, at least a driving chip, a plurality of data lines and a plurality of touch signal read-out lines. The peripheral region is disposed around the pixel array. The driving chip is disposed in the peripheral region. The data lines are disposed in the peripheral region, wherein each data line comprises a first section and a second section. The first section of the data line is electrically connected to the driving chip and the second section of the data line is electrically connected to the pixel array. The second sections of any neighbor data lines have an equal distance. The touch signal read-out lines are disposed in the peripheral region, wherein each touch signal read-out line comprises a first section and a second section. The first section of each touch signal read-out line is electrically connected to the corresponding driving chip and the second section of each touch signal read-out line is electrically connected to the pixel array. The second section of at least one of the touch sensing read-out lines includes an initial point and a winding portion, wherein the winding portion is disposed on at least one side of a vertical extending line of the initial point, the winding portion winds to and fro along a horizontal direction and along a vertical direction, and the winding portion is asymmetrical with respect to the vertical extending line of the initial point.

In accordance with another embodiment of the present invention, a touch display device comprises a touch display substrate mentioned above.

The touch display panel of the present invention renders the touch signal read-out lines and the data lines an excellent resistance matching by disposing the touch signal read-out lines with asymmetric design and therefore effectively improves the uniformity of the display images and the touch sensing sensitivity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a touch display substrate of a touch display device of the preferred embodiment of the present invention.

FIG. 2 illustrates the partial magnification diagram of the data lines and the touch signal read-out lines of the touch display substrate of the FIG. 1.

FIG. 3 is a partial magnification diagram of the data lines and the touch signal read-out lines of the touch display panel according to another preferred embodiment of the present invention.

FIG. 4 is a partial magnification diagram of the second section of the data line and the second section of the touch signal read-out line of the embodiment of the present invention.

FIG. 5 is the partial magnification diagram of the second sections of the data lines and the second sections of the touch signal read-out lines according to still another preferred embodiment of the present invention.

### DETAILED DESCRIPTION

To provide a better understanding of the present invention, preferred embodiments will be made in detail. The preferred embodiments of the present invention are illustrated in the accompanying drawings with numbered elements.

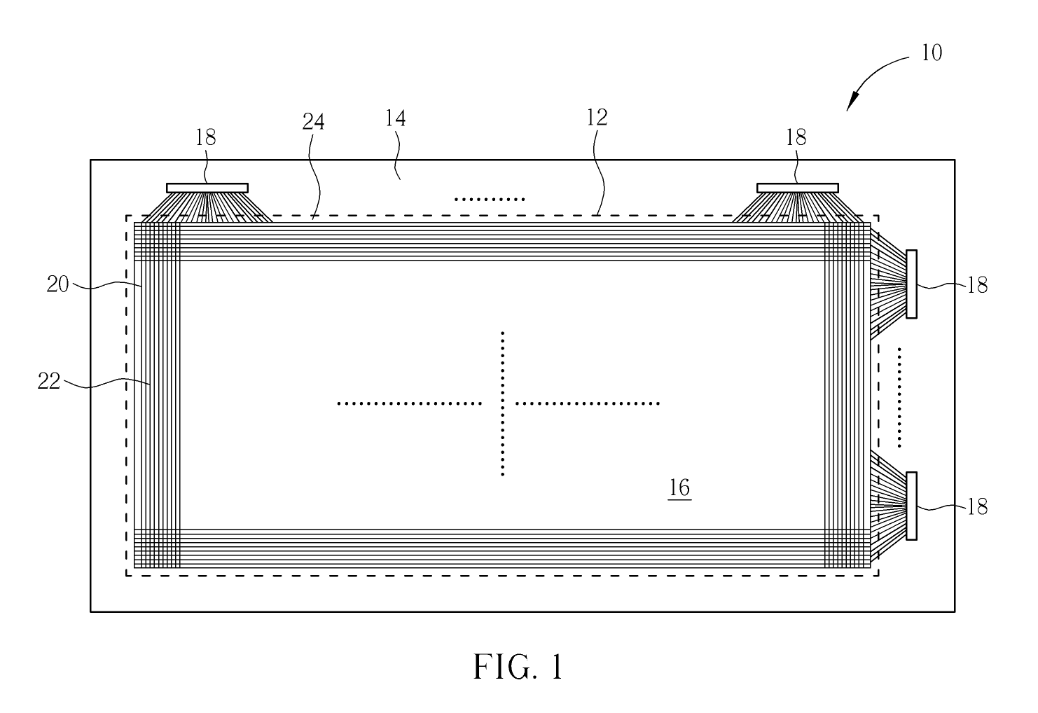

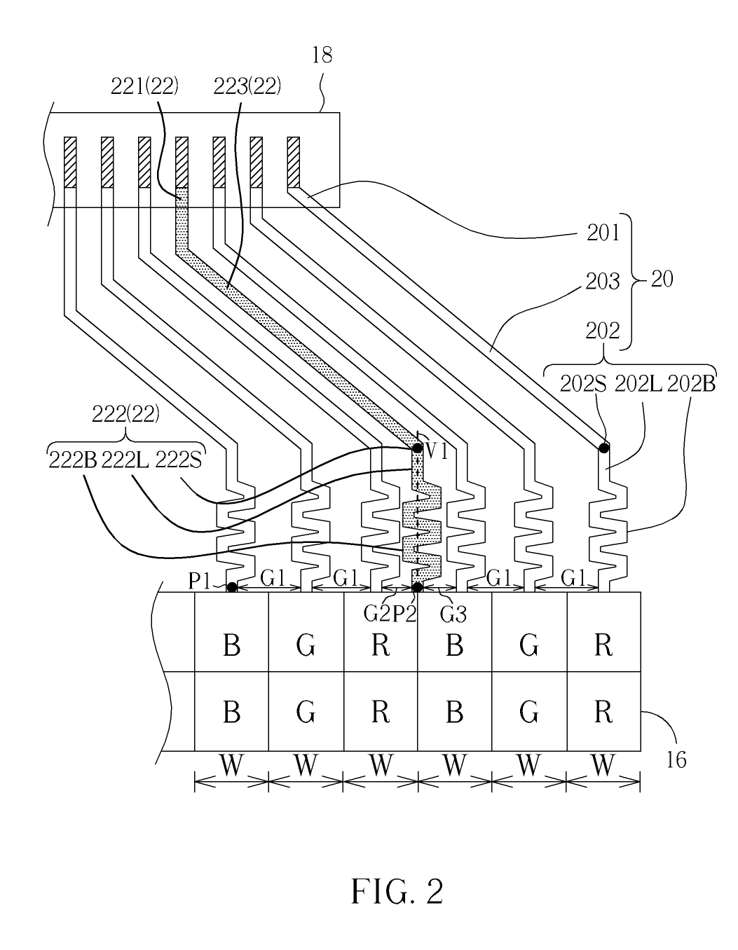

Please refer to FIG. 1 and FIG. 2. FIG. 1 illustrates a touch display substrate of a touch display device of the preferred embodiment of the present invention. FIG. 2 illustrates the partial magnification of the data lines and the touch signal read-out lines of the touch display substrate of the FIG. 1. As shown in FIG. 1 and FIG. 2, the touch display device of the present invention is a display which integrates a touch panel into a display panel, wherein the touch panel can be a capacitive touch panel but is not limited thereto. The touch display device of the present invention can be any kind of touch display device, such as a liquid crystal touch display device, an organic light-emitting touch display device, or an electro-phoretic touch display device but is not limited thereto. Moreover, the touch display device can further include another substrate (not shown), and a display medium layer (not shown) disposed between a touch display substrate 10 and another substrate. The display medium layer can be a liquid crystal layer, an organic light-emitting layer, or an electro-phoretic layer, depending on the different kinds of the touch display devices. The touch display substrate 10 is an array substrate with switch devices disposed thereon. The touch display substrate 10 includes a display region 12, a peripheral region 14, a pixel array 16, at least a driving chip 18, a plurality of data lines 20, a plurality of touch signal read-out lines 22, and a plurality of gate lines 24. The pixel array 16 is disposed in the display region 12 and the peripheral region 14 is disposed around the pixel array 16, that is to say, the peripheral region 14 can be disposed in one side, two sides, or three sides of the display region 12 or even around the display region 12. The driving chip 18 is disposed in the peripheral region 14. The data lines 20 are disposed in the display region 12, extended to the peripheral region 14, and electrically connected to the driving chip 18. The touch signal read-out lines 22 are disposed in the display region 12, extended to the peripheral region 14, and electrically connected to the driving chip 18. The gate lines 24 are disposed in the display region 12, extended to the peripheral region 14, and electrically connected to the driving chip 18. The pixel array 16 includes a plurality of sub pixels, which are arranged in array, such as red sub pixels R, blue sub pixels B, and green sub pixels G and each of the sub pixels has a width W. The data lines 20 are used for transferring the data signal generated by the driving chip 18 to the pixel array 16, and the touch signal read-out lines 22 are used for transferring the touch input signal received by a touch sensor device (which is not shown in the figure) to the driving chip 18 in order to determine the exact position where has been touched. In the embodiment of the present invention, the circuit for generating data signal and the circuit for dealing with touch input signal are integrated into the driving chip 18. Therefore, the touch signal read-out lines 22 are disposed between parts of the neighboring data lines 20 and electrically connected to the corresponding driving chip 18; moreover, the gate lines 24 are connected to the corresponding driving chip 18.

In the embodiment of the present invention, each of the data lines 20 includes a first section 201, a second section 202, and a third section 203, wherein the first section 201 of each of the data lines 20 is electrically connected to the driving chip 18, the second section 202 of each of the data lines 20 is electrically connected to the pixel array 16, and the third section 203 of each of the data lines 20 is disposed between and connected to the first section 201 and the second section 202. The distance G1 between the connection nodes of the second sections 202 of any neighboring data lines 20 and the pixel array 16 is equal. Furthermore, depending on the different disposed positions, the third sections 203 of parts of the data lines 20 are connected to the first section 201 and the second section 202 of the corresponding data lines 20 in a slanted direction. The connection in a slanted direction is that the direction of the third section 203 and the direction of the first section 201 have a non-right angle, and the direction of the third section 203 and the direction of the second section 202 have a non-right angle. In this embodiment, for example, the first section 201 and the second section 202 of parts of the data lines 20 are arranged in a vertical direction, while the third section 203 of the corresponding data lines 20 is arranged in a slanted direction which is neither perpendicular nor parallel to the direction of the first section 201 or the second section 202. Moreover, depending on the different disposed positions, the third section 203 of parts of the data lines 20 and the first section 201 and the second section 202 of the corresponding data lines 20 could be connected as a straight line, that is to say, the first section 201, the second section 202, and the third section 203 of parts of the data lines 20 form a straight line. Furthermore, the second section 202 of parts of the data lines 20 has an initial point 202S, a straight segment 202L, and a winding segment 202B, wherein the straight segment 202L is disposed between and respectively connected to the initial point 202S and the winding segment 202B.

In this embodiment, each of the touch signal read-out lines 22 includes a first section 221, a second section 222, and a third section 223, wherein the first section 221 of each of the touch signal read-out lines 22 is electrically connected to the corresponding driving chip 18, the second section 222 of each of the touch signal read-out lines 22 is electrically connected to the pixel array 16, and the third section 223 of each of the touch signal read-out lines 22 is disposed between and connected to the first section 221 and the second section 222. Moreover, depending on the different disposed positions, the third section 223 of parts of the touch signal read-out lines 22 is connected to the first section 221 and the second section 222 of the corresponding touch signal read-out lines 22 in a slanted direction. The definition of the connection in a slanted direction mentioned above is the same as the definition mentioned in the above paragraph. That is, in this embodiment, the first section 221 and the second section 222 of parts of the touch signal read-out lines 22 is arranged in a vertical direction, while the third section 223 is arranged in a slanted direction which is neither perpendicular nor parallel to the first section 221 or the second section 222. Moreover, depending on the different disposed positions, the third section 223 of the touch signal read-out lines 22 and the first section 221 and the second section 222 of the corresponding touch signal read-out lines 22 could be connected as a straight line. Further, the second section 222 of at least one touch signal read-out line 22 has an initial point 222S, a straight segment 222L, and a winding segment 222B, wherein the straight segment 222L is disposed between and respectively connected to the initial point 222S and the winding segment 222B.

In this embodiment, the data line 20 can be constructed by a single conductive layer, which can be the same conductive layer as a first metal layer or a second metal layer of the devices of the pixel array 16, or by a stacked structure of a plurality of conductive layers, such as by a stack of the first metal layer and the second metal layer or by a stack of at least a metal layer and a transparent conductive layer, but is not limited thereto. Also, the touch signal read-out line 22 can be constructed by a single conductive layer, such as the first metal layer which is the same layer with the gate line 24 or the second metal layer which is the same layer with the data line 20, or by a stack structure of a plurality of conductive layer, such as by a stack of the first metal layer and the second metal layer or by a stack of at least a metal layer and a transparent conductive layer, but is not limited thereto. Moreover, the data lines 20 and the touch signal read-out lines 22 can be constructed by a same conductive layer or a plurality of the same conductive layers and defined by a same mask, but are not limited thereto.

Because of the different sizes and relative positions of the pixel array 16 and the driving chip 18, each data line 20 and each touch signal read-out line 22 may have different length so that each data line 20 and each touch signal read-out line 22 have different resistances. Therefore, the winding segment 202B of the second section 202 of the data line 20 and the winding segment 222B of the second section 222 of the touch signal read-out line 22 have a function of adjusting resistance. More specifically, by change the lengths of the winding segment 202B of the second section 202 of the data line 20 and the winding segment 222B of the second section 222 of the touch signal read-out line 22, times of winding, or the composition and/or construction of conductive layers, the data line 20 and the touch signal read-out line 22 can substantially have equal or similar resistance. It is appreciated that the winding segment 202B of the data line 20 and the winding segment 222B of the touch signal read-out line 22 in this embodiment are zigzag patterns, but are not limited thereto. Any other types of winding patterns may be used to adjust resistance.

In the present invention, there is an equal distance between the connection nodes of the second sections 202 of the data lines 20 and the pixel array 16, and the connection nodes are corresponding to the sub pixels R, G, and B of the pixel array 16, respectively. In other words, the distance G1 between the connection nodes P1 of the second section 202 of each of the data lines 20 and the pixel array 16 is substantially equal to the width W of the sub pixels R, G, and B. On the other hand, the area for disposing the winding segment 202B of the second section 202 of the data line 20 and the winding segment 222B of the second section 222 of the touch signal read-out line 22 is equally distributed for accommodating the data line 20 and the touch signal read-out line 22. For example, when the touch signal read-out line 22 is disposed between two neighboring data lines 20, there is a distance G2 between the connection node P2 of the touch signal read-out line 22 and the pixel array 16 and the connection node P1 of the data line 20 which is disposed on one side of the touch signal read-out line 22 and the pixel array 16, and there is a distance G3 between the connection node P2 of the touch signal read-out line 22 and the pixel array 16 and the connection node P1 of the data line 20 which is disposed on the other side of the touch signal read-out line 22 and the pixel array 16. The sum of the distance G2 and the distance G3 is equal to the distance G1. By the asymmetric design of the winding segment 222B of the second section 222 of the touch signal read-out line with respect to the vertical extending line V1 of the initial point 222S and by adjusting the length and the times of winding, the winding segment 222B of the second section 222 of the touch signal read-out line 22 can be disposed in the area between the winding segment 202B of the neighboring data lines 20. In other words, in the peripheral region 14, the second section 202 of the data line 20 and the second section 222 of the touch signal read-out line 22 are substantially arranged uniformly, so that the touch signal read-out lines 22 and data lines 20 have substantially equal resistance, and the uniformity of the display images and touch sensitivity are therefore improved. More precisely, on the condition that the distance G1 between the connection node P1 of the second section 202 of each of the data lines 20 and the pixel array 16 is identical, the asymmetric design of the winding segment 222B of the second section 222 of the touch signal read-out line 22 and/or the asymmetric design of the winding segment 202B of the second section 202 of the data line 20 allow to equally distribute the winding segment 202B of the second section 202 of the data line 20 and the winding segment 222B of the second section 222 of the touch signal read-out line 22 in the limited area so that all of the touch signal read-out lines 22 and data lines 20 have substantially equal resistance.

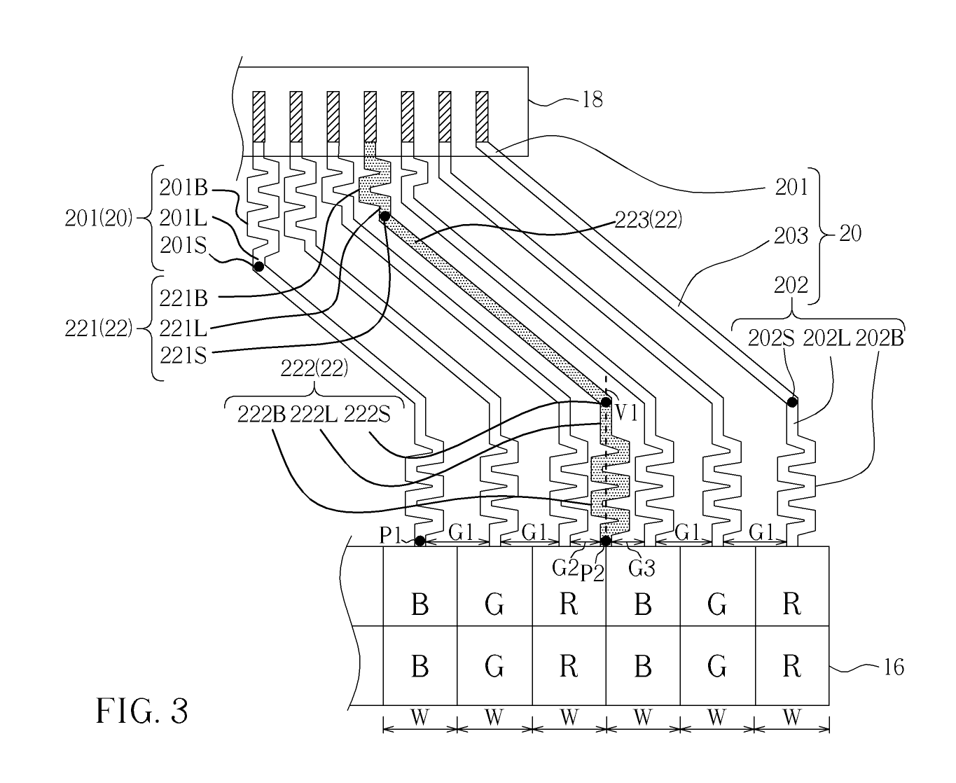

Please refer to FIG. 3. FIG. 3 is a partial magnification diagram of the data lines and the touch signal read-out lines of the touch display panel according to another preferred embodiment of the present invention. In order to compare the difference between the embodiments more easily and to describe briefly, same components are denoted by same numerals, and repeated parts are not redundantly described. As shown in FIG. 3, different from the embodiment mentioned above, in this embodiment, in case that the space is sufficient, in order to further make the resistance of the data lines 20 and the touch signal read-out lines 22 more matching, the first section 201 of the data lines 20 and/or the first section 221 of the touch signal read-out lines 22 can also have the winding design. For instance, in this embodiment, the first sections 201 of parts of the data lines 20 can have an initial point 201S, a straight segment 201L, and a winding segment 201B, wherein the straight segment 201L is disposed between and respectively connected to the initial point 201S and the winding segment 201B. Moreover, the first sections 221 of parts of the touch signal read-out lines 22 can also have an initial point 221S, a straight segment 221L, and a winding segment 221B, wherein the straight segment 221L is disposed between and respectively connected to the initial point 221S and the winding segment 221B. Similarly, both of the winding segment 201B of the first section 201 of the data line 20 and the winding segment 221B of the first section 221 of the touch signal read-out line 22 have the function of adjusting resistance. More specifically, by change the length of the winding segment 201B of the first section 201 of each data line 20 and the winding segment 221B of the first section 221 of each touch signal read-out line 22, winding times, or the composition and/or construction of conductive layers, the data line 20 and the touch signal read-out line 22 can substantially have equal or similar resistance. It is noted that the winding segment 201B of the data line 20 and the winding segment 221B of the touch signal read-out line 22 in this embodiment are zigzag patterns, but are not limited thereto. Any other types of winding patterns may be used to adjust resistance

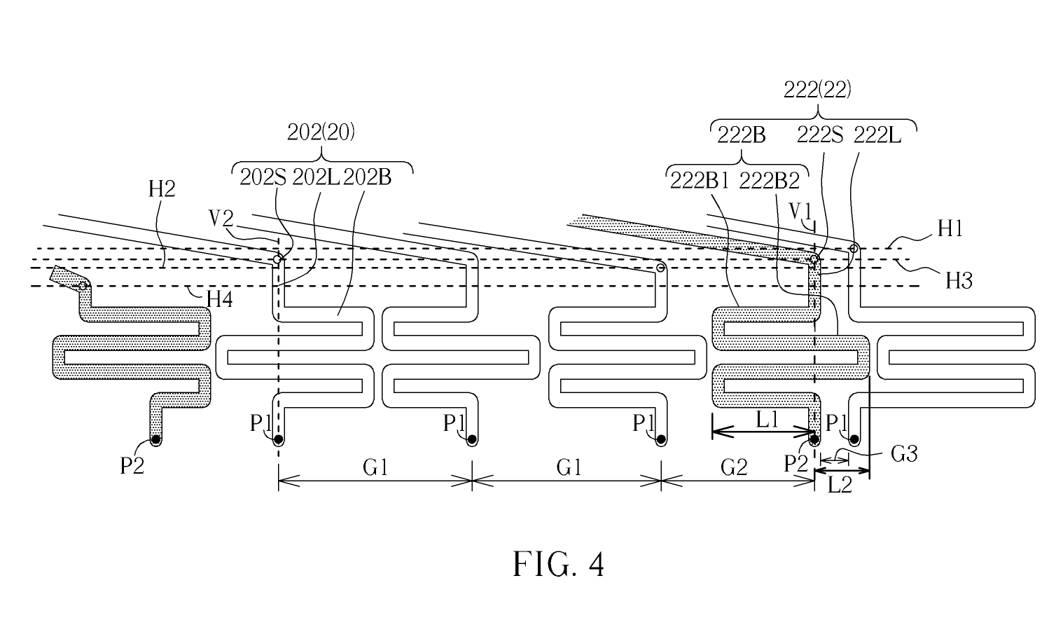

Please refer to FIG. 4. FIG. 4 a partial magnification diagram of the second section of the data line and the second section of the touch signal read-out line of the embodiment of the present invention. As shown in FIG. 4, the winding segment 202B of the data line 20 is disposed on one side of the vertical extending line V2 of the initial point 202S (which is the direction parallel to the straight segment 202L) and repeatedly winded along the horizontal and vertical directions. In this embodiment, the winding segment 202B of the data line 20 can be either symmetric or asymmetric with respect to the vertical extending line V2 of the initial point 202S. Moreover, the winding segment of the second section 222 of at least one touch signal read-out line 22 is disposed on at least one side of the vertical extending line V1 (which is the direction parallel to the straight segment 222L) of the initial point 222S and winded repeatedly along the horizontal and vertical directions, and the winding segment 222B is asymmetric with respect to the vertical extending line V1 of the initial point 222S. In this embodiment, at least one touch signal read-out line 22 is disposed between the neighboring data lines 20 and the winding segment 222B of the second section 222 of the touch signal read-out line 22 is repeatedly winded along the horizontal and vertical directions. In this embodiment, the illustrated touch signal read-out line 22 is winded repeatedly three times so that the winding segments 222B, which includes a first winding segment 222B1 and a second winding segment 222B2, are respectively disposed on the two opposite sides of the vertical extending line V1 of the initial point 222S, wherein the first winding segment 222B1 has a first length L1 along the horizontal direction, the second winding segment 222B2 has a second length L2 along the horizontal direction, and the first length L1 is not equal to the second length L2 so that the winding segment 222B is asymmetric with respect to the vertical extending line V1 of the initial point 222S. The times of winding of the data lines 20 or the touch signal read-out lines 22 is not limited. The skilled can determine the times of winding of any data line 20 or touch signal read-out line 22 and adjust the first length L1 of the first winding segment 222B1 and the second length L2 of the second winding segment 222B2 based on the disposed position of the data line 20 or the touch signal read-out line 22 or based on the required resistance of the data line 20 or the touch signal read-out line 22.

Further, in order to adjust the resistances of each of the data lines 20 and the touch signal read-out lines 22, at least one of the initial points 202S of the second sections 202 of the data lines 20 and other initial points 202S of the second sections 202 of the data lines 20 may be disposed on different horizontal lines. As shown in FIG. 4, for instance, one initial point 202S of the second section 202 of the data line 20 is disposed on a horizontal line H1 and the other initial point 202S of the second section 202 of the data line 20 is disposed on a horizontal line H2. In addition, at least one of the initial point 222S of the second section 222 of the touch signal read-out line 222 and other initial point 222S of the second section 222 of the touch signal read-out line 222 may be disposed on different horizontal lines. As shown in FIG. 4, for instance, one initial point 222S of the second section 222 of the touch signal read-out line 22 in the right side of FIG. 4 is disposed on a horizontal H3 and the other initial point 222S of the second section 222 of the touch signal read-out line 22 in the left side of FIG. 4 is disposed on a horizontal line H4. Furthermore, at least one of the initial points 202S of the second section 202 of the data line 20 and at least one of the initial point 222S of the second section 222 of the touch signal read-out line 22 may be disposed on different horizontal lines As shown in FIG. 4, for instance, one initial point 202S of the second section 202 of the data line 20 is disposed on the horizontal line H1 and the neighboring initial point 222S of the second section 222 of the touch signal read-out line 22 is disposed on the horizontal line H3.

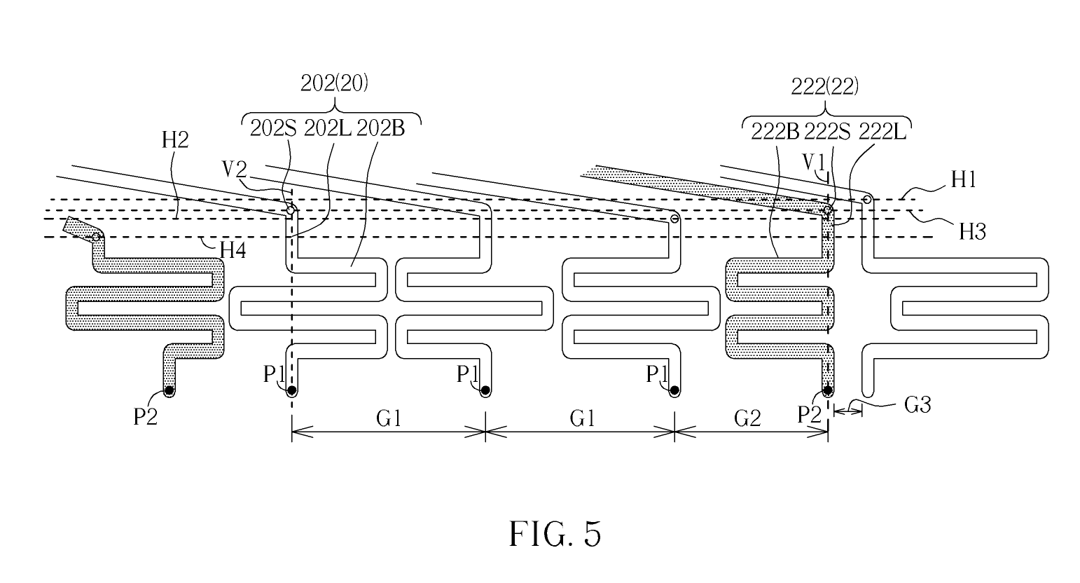

Please refer to FIG. 5. FIG. 5 is the partial magnification diagram of the second sections of the data lines and the second sections of the touch signal read-out lines according to still another preferred embodiment of the present invention. In order to compare the difference between the embodiments more easily and to describe briefly, same components are denoted by same numerals, and repeated parts are not redundantly described. As shown in FIG. 5, the winding segment 222B of the second section 222 of the touch signal read-out line 22 of this embodiment is only disposed on one side (the left side) of the vertical extending line V1 of the initial point 222S and is not extended to the other side (the right side) of the vertical extending line V1 so that the winding segment 222B only has the first winding segment or the second winding segment compared to the embodiment of FIG. 4. Similarly, in order to adjust the resistance of each of the data lines 20 and the touch signal read-out lines 22, at least one of the initial point 202S of the second section 202 of the data line 20 and another initial point 202S of the second section 202 of the data line 20 may be disposed on different horizontal lines. As shown in FIG. 5, for instance, one initial point 202S of the second section 202 of the data line 20 is disposed on the horizontal line H1 and another initial point 202S of the second section 202 of the data line 20 is disposed on the horizontal line H2. Also, at least one initial point 222S of the second section 222 of the touch signal read-out line 22 and another initial point 222S of the second section 222 of the touch signal read-out line 22 may be disposed on different horizontal lines. As shown in FIG. 5, for instance, the initial point 222S of the second section 222 of the touch signal read-out line 22 on the right side of FIG. 5 is disposed on the horizontal line H3 and another initial point 222S of the second section 222 of the touch signal read-out line 22 on the left side of FIG. 5 is disposed on the horizontal line H4. In addition, at least one initial point 202S of the second section 202 of the data line 20 and at least one initial point 222S of the second section 222 of the touch signal line 22 may be disposed on different horizontal lines. As shown in FIG. 5, for instance, one initial point 202S of the second section 202 of the data line 20 is disposed on the horizontal line H1 and one initial point 222S of the second section 222 of the touch signal read-out line 22 is disposed on the horizontal line H3. FIG. 4 and FIG. 5 take the second sections 202 of the data lines 20 and the second sections 222 of the touch signal read-out lines 22 as an example to illustrate the winding and asymmetric design of the data lines 20 and the touch signal read-out lines 22, the present invention is not limited thereto. For instance, the first sections 201 of the data lines 20 and/or the first sections 221 of the touch signal read-out lines 22 can also take any kind of winding and asymmetric design mentioned above.

Please refer to table 1 and table 2. Table 1 is a comparison of the resistances between the touch signal read-out lines of the conventional design and the resistances of the touch signal read-out lines of the present invention. Table 2 is a comparison of the resistances between the data lines of the conventional design and the resistances of data lines of the present invention. As shown in table 1, the measured result shows that with the conventional design, the maximum resistance of all of the touch signal read-out lines is 575Ω (ohm), the minimum resistance of all of the touch signal read-out lines is 127Ω (ohm), and the difference between the maximum resistance and the minimum resistance is 448Ω (ohm); with the design of the present invention, the maximum resistance of all of the touch signal read-out lines is 575Ω (ohm), the minimum resistance of all of the touch signal read-out lines is 536Ω (ohm), and the difference between the maximum resistance and the minimum resistance is 39Ω (ohm). As shown in table 2, the measured result shows that with the conventional design, the resistances of the data lines are substantially between 624Ω (ohm) to 649Ω (ohm) and the absolute value of the difference of the resistances of the neighboring data lines is 16Ω (ohm); on the other hand, with the design of the present invention, the resistances of the data lines are substantially between 554Ω (ohm) to 576Ω (ohm) and the absolute value of the difference of the resistances of the neighboring data lines is less than 5Ω (ohm). Also, comparing table 1 and table 2, there is a significant improvement on the difference of the resistances between the data lines and the touch signal read-out lines. The above measured results clearly show that the touch signal read-out lines with asymmetric design of the present invention can effectively adjust the resistances of the data lines and the touch signal read-out lines so that the resistances are matched between each of the touch signal read-out lines, between each of the data lines, and between the touch signal read-out line a and the data line.

TABLE 1

| | Maximum | Minimum | |
|---|---|---|---|
| | resistance | resistance | Difference |
| | (R_{Max}) | (R_{Min}) | (R_{Max} − R_{Min}) |
| The conventional | 575 Ω | 121 Ω | 448 Ω |
| Design | | | |
| The present | 575 Ω | 536 Ω | 39 Ω |
| invention | | | |

TABLE 2

| The conventional design | | | The present invention | | |
|---|---|---|---|---|---|
| | | Absolute | | | Absolute |
| | | value of the | | | value of the |
| | | difference of the | | | difference of the |
| | | resistances of the | | | resistances of the |
| | Resistance | neighboring | | Resistance | neighboring |
| The data line | (Ω) | data lines (Ω) | The data line | (Ω) | data lines (Ω) |
| Line_149 | 629 | 4 | Line_149 | 554.88 | 4.55 |
| Line_150 | 633 | 5 | Line_150 | 559.43 | 4.26 |
| Line_153 | 638 | 2 | Line_153 | 563.69 | 1.58 |
| Line_153 | 640 | 16 | Line_153 | 565.27 | 2.05 |
| Line_154 | 624 | 7 | Line_154 | 567.32 | 4.55 |
| Line_155 | 631 | 16 | Line_155 | 571.87 | 2.17 |
| Line_156 | 647 | 2 | Line_156 | 574.04 | 1.53 |
| Line_157 | 649 | 2 | Line_157 | 575.57 | 1.53 |

In conclusion, the touch display device with the touch signal read-out lines of an asymmetric design of the present invention can render the touch signal read-out lines and the data lines excellent resistance matching so that the uniformity of the display images and touch sensitivity can be effectively improved.

Those skilled in the art will readily observe that numerous modifications and alterations of the device and method may be made while retaining the teachings of the invention.

What is claimed is:

1. A touch display substrate, comprising:
a pixel array;
a peripheral region, disposed around the pixel array;
at least a driving chip, disposed in the peripheral region;
a plurality of data lines, disposed in the peripheral region, wherein each of the data lines includes a first section and a second section, the first section of each of the data lines is electrically connected to the driving chip, the second section of each of the data lines is electrically connected to the pixel array with a connection node, and the connection nodes of any two neighboring second sections of the data lines have an equal distance; and
a plurality of touch sensing read-out lines, disposed in the peripheral region, wherein each of the touch sensing read-out lines includes a first section and a second section, the first section of each of the touch sensing read-out lines is electrically connected to the corresponding driving chip, and the second section of each of the touch sensing read-out lines is electrically connected to the pixel array;
wherein the second section of at least one of the touch sensing read-out lines includes an initial point and a winding segment, the winding segment is disposed on at least one side of a vertical extending line of the initial point, winds to and fro along a horizontal direction and a vertical direction, and is asymmetrical with respect to the vertical extending line of the initial point.

2. The touch display substrate according to claim 1, wherein the winding segment of the second section of the at least one of the touch sensing read-out lines includes a first winding line and a second winding line disposed respectively on the opposite sides of the vertical extending line of the initial point; the first winding line has a first length along the horizontal direction, the second winding line has a second length along the horizontal direction, and the first length is not equal to the second length.

3. The touch display substrate according to claim 1, wherein the winding segment of the second section of the at least one of the touch sensing read-out lines is disposed only on a side of the vertical extending line of the initial point.

4. The touch display substrate according to claim 1, wherein the second section of each of the touch sensing read-out lines has an initial point, and at least one of the initial points of the second sections of the touch sensing read-out lines and other initial points of the second sections of the touch sensing read-out lines are located on the different horizontal lines.

5. The touch display substrate according claim 1, wherein the second section of the at least one of the touch sensing read-out lines has a straight segment; and the straight segment is disposed between the initial point and the winding segment and connected to the initial point and the winding segment.

6. The touch display substrate according claim 1, wherein the first section of the at least one of the touch sensing read-out lines has a winding segment.

7. The touch display substrate according claim 1, wherein each of the touch sensing read-out lines further includes a third section disposed between and connected to the first section and the second section of the corresponding touch sensing read-out line; and at least a part of the third sections of the touch sensing read-out lines are connected to the first section and the second section of the corresponding touch sensing read-out line in a slanted direction.

8. The touch display substrate according to claim 1, wherein each of the data line further includes a third section disposed between and connected to the first section and second section of the corresponding data line; and at least a part of the third sections of the data lines are connected to the first section and the second section of the corresponding data line in a slanted direction.

9. The touch display substrate according to claim 1, wherein at least a part of the second sections of the data lines have a winding segment.

10. The touch display substrate according to claim 1, wherein at least a part of the first sections of the data lines have a winding segment.

11. The touch display substrate according to claim 1, wherein at least one of the touch sensing read-outs is disposed between the data lines.

12. A touch display device, comprising:
a touch display substrate according to claim 1.

13. The touch display device according to claim 12, wherein the touch display device includes a liquid crystal touch display device, an organic light-emitting touch display device, or an electro-phoretic touch display device.
